(19) United States
(12) Patent Application Publication
(10) Pub. No.: US 2024/0089385 A1
(43) Pub. Date: Mar. 14, 2024

(54) IMAGE PROCESSING APPARATUS, NON-TRANSITORY COMPUTER READABLE MEDIUM, AND IMAGE PROCESSING METHOD

(71) Applicant: FUJIFILM Business Innovation Corp., Tokyo (JP)

(72) Inventors: Shigeru TAMURA, Kanagawa (JP); Yuki TSUCHITOI, Kanagawa (JP); Manabu HAYASHI, Kanagawa (JP); Fumihito KASAI, Kanagawa (JP); Kanade KUBOTA, Kanagawa (JP); Yuki IGUCHI, Kanagawa (JP); Yuto SHIONO, Kanagawa (JP)

(73) Assignee: FUJIFILM Business Innovation Corp., Tokyo (JP)

(21) Appl. No.: 18/180,406

(22) Filed: Mar. 8, 2023

(30) Foreign Application Priority Data
Sep. 13, 2022 (JP) 2022-145649

(51) Int. Cl. H04N 1/00

(52) U.S. Cl. CPC H04N 1/00702; H04N 1/00352; H04N 1/0044; H04N 1/00748; H04N 2201/0081

(57) ABSTRACT

An image processing apparatus includes a processor configured to: extract position coordinates of each document image from an entire image resulting from photographing multiple documents; perform a first operation that extracts, from the document images included in the entire image, a first document image having two sides parallel with a direction of arrangement of the documents and having a first side of the two sides being a far side from a first coordinate axis, the first side having the shortest distance to the first coordinate axis, the first coordinate axis being in parallel with the direction of the arrangement of the documents set with respect to an origin of the entire image; perform a second operation that extracts, as an document image of the same group, a second document image overlapping an extension of the first side of the extracted first image document; and perform a third operation that sets a page number on each of the extracted document images of the same group in an order of closeness from near to far distance to the origin.

### CROSS-REFERENCE TO RELATED APPLICATIONS

This application is based on and claims priority under 35 USC 119 from Japanese Patent Application No. 2022-145649 filed Sep. 13, 2022.

### BACKGROUND

### (i) Technical Field

The present disclosure relates to an image processing apparatus, a non-transitory computer readable medium, and an image processing method.

### (ii) Related Art

Japanese Patent No. 6807630 discloses an image reading apparatus. The image reading apparatus acquires placement area data related to an area of a document holder having multiple documents placed thereon, and attaches an order of arrangement of documents on the document holder to document image data, using a multi-crop function that extracts document image data on each document.

Japanese Unexamined Patent Application Publication No. 2012-104986 discloses a multi-form scanning method. When a floor-standing scanner scans multiple forms in batch to acquire image data on the forms, the multi-form scanning is enabled to record the image data with information on the order of the forms attached to each form.

Japanese Unexamined Patent Application Publication No. 2014-216953 discloses an image processing apparatus that identifies the order of multiple concurrently-photographed documents and then organizes, stores, and outputs document data in accordance with the identified order of the documents and performs other operations on the document image data.

Japanese Patent No. 6849387 discloses an image processing apparatus. When a set of multiple pages placed side by side on a document holder is read and converted into a file, the image processing apparatus automatically displays a default order of the pages so that a user may modify the default order.

Japanese Unexamined Patent Application Publication No. 2008-034973 discloses an image processing apparatus that is enabled to output, in the order of arrangement of the documents on a document holder, read image data on multiple documents placed on the document holder.

An image processing apparatus, such as a multi-function apparatus, may manage multiple document images as a single document by extracting a document image from an entire image resulting from photographing multiple documents placed on a document holder, such as a platen, by setting a page number on each document image, and by arranging the document images in the order of page numbers.

When multiple documents are arranged in a matrix of rows and columns with respect to the top left position of the document holder, the image processing apparatus may set page numbers to the document images on a top row, extracted from the entire image, in the order of page numbers from left to right and may also set page numbers on the document images on a second row and subsequent rows in a similar fashion.

However, lower sides or upper sides of the document images may not possibly be aligned with the direction of row or left sides or right sides of the document images may not possibly be aligned with the direction of column. If the documents are randomly arranged in this way, it may be difficult to set the page numbers correctly.

### SUMMARY

Aspects of non-limiting embodiments of the present disclosure relate to providing an image processing apparatus, a non-transitory computer readable medium, and an image processing method, enabled to set the pages even when multiple documents are randomly placed in a matrix of rows and columns.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing apparatus comprising a processor configured to: extract position coordinates of each document image from an entire image resulting from photographing a plurality of documents; perform a first operation that extracts, from the document images included in the entire image, a first document image having two sides parallel with a direction of arrangement of the documents and having a first side of the two sides being a far side from a first coordinate axis, the first side having a shortest distance to the first coordinate axis, the first coordinate axis being in parallel with the direction of the arrangement of the documents set with respect to an origin of the entire image; perform a second operation that extracts, as an document image of a same group, a second document image overlapping an extension of the first side of the extracted first document image, the extension extending in the direction of the arrangement; and perform a third operation that sets a page number on each of the extracted document images of the same group in an order of closeness from near to far distance to the origin.

### BRIEF DESCRIPTION OF THE DRAWINGS

Exemplary embodiment of the present disclosure will be described in detail based on the following figures, wherein:

FIGS. 1A and 1B illustrate the appearance of an image forming apparatus of an exemplary embodiment of the disclosure, wherein FIG. 1A is a side view of the image processing apparatus and FIG. 1B is a front view of the image processing apparatus;

FIG. 2 is a block diagram illustrating a hardware configuration of the image processing apparatus:

FIG. 3 is a functional block diagram of the image processing apparatus;

FIG. 4 illustrates an operation that is performed to set a page number on each document image in a first setting;

FIG. 5 illustrates an operation that is performed to set a page number on each document image in the first setting;

FIG. 6 illustrates an operation that is performed to set a page number on each document image in the first setting;

FIG. 7 illustrates an operation that is performed to set a page number on each document image in the first setting;

FIG. 8 illustrates an operation that is performed to set a page number on each document image in the first setting;

FIG. 9 illustrates an operation that is performed to set a page number on each document image in the first setting;

FIG. 10 illustrates an operation that is performed to set a page number on each document image in the first setting;

FIG. 11 illustrates an operation that is performed to set a page number on each document image in the first setting;

FIG. 12 illustrates an operation that is performed to set a page number on each document image in the first setting;

FIG. 13 illustrates an operation that is performed to set a page number on each document image in the first setting;

FIG. 14 illustrates an operation that is performed when a document image is rectangular and has no sides parallel with a direction of arrangement of documents;

FIG. 15 illustrates an operation that is performed when a document image is not rectangular;

FIG. 16 illustrates an operation that is performed to set a page number on each document image in the second setting;

FIG. 17 illustrates an operation that is performed to set a page number on each document image in the second setting;

FIG. 18 illustrates an operation that is performed to set a page number on each document image in the second setting;

FIG. 19 illustrates an operation that is performed to set a page number on each document image in the second setting;

FIG. 20 illustrates an operation that is performed to set a page number on each document image in the second setting;

FIG. 21 illustrates an operation that is performed to set a page number on each document image in the second setting;

FIG. 22 illustrates an operation that is performed to set a page number on each document image in the second setting;

FIG. 23 illustrates an operation that is performed to set a page number on each document image in the second setting;

FIG. 24 illustrates an operation that is performed to set a page number on each document image in the second setting;

FIG. 25 illustrates an operation that is performed to set a page number on each document image in the second setting;

FIG. 26 illustrates a setting configuration of an entire image and page numbers in a third setting;

FIG. 27 illustrates the setting configuration of the entire image and page numbers in a fourth setting;

FIG. 28 illustrates the page numbers that are aligned with the document images in the entire image;

FIG. 29 illustrates the page numbers aligned with the document images in the entire image wherein part of the document images is moved from the state illustrated in FIG. 28;

FIG. 30 illustrates a set of images that are arranged in accordance with the order of page numbers set on the document images;

FIG. 31 illustrates a set of images that are arranged in accordance with the order of page numbers set on the document images; and

FIG. 32 is a flowchart illustrating the flow of a process that sets the page numbers on the document images in the entire image.

### DETAILED DESCRIPTION

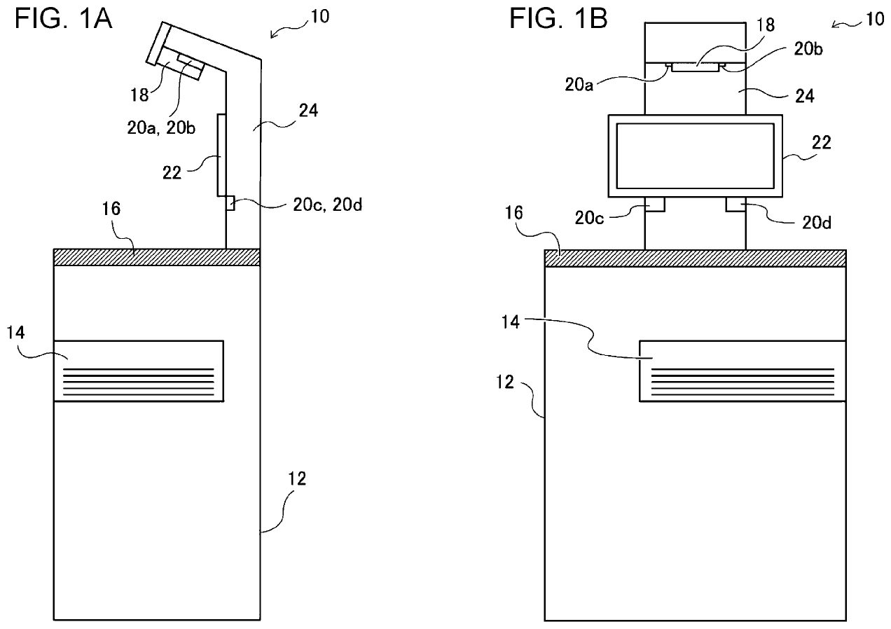

Exemplary embodiment of the disclosure is described below in detail with reference to the drawings. FIGS. 1A and 1B illustrate the appearance of an image forming apparatus 10 of an exemplary embodiment of the disclosure. FIG. 1A is a side view of the image processing apparatus and FIG. 1B is a front view of the image processing apparatus. The image forming apparatus 10 is, for example, a multi-function apparatus and typically installed in an office.

Referring to FIG. 1, the image forming apparatus 10 includes an apparatus body 12, discharge tray 14, document holder 16, photographing device 18, irradiation device 20 including four light sources 20a, 20b, 20c, and 20d, operation panel 22, and the like.

The discharge tray 14 receives paper sheets serving as an example of a medium. The discharge tray 14 is mounted at a level where a user in a standing position may pick up the medium.

The document holder 16, as described in greater detail below, is the top surface of the apparatus body 12 and thus mounted in the top portion of the apparatus body 12. The document holder 16 is located above the discharge tray 14 in a vertical direction. The document holder 16 is configured to accommodate paper sheets, business cards, receipts, and the like.

The photographing device 18 includes an imaging device, such as a charge-coupled device (CCD), and acquires image data by photographing an object, such as a document. The photographing device 18 is mounted at a position above the document holder 16 and configured to photograph the document placed on the document holder 16 from above. When the top surface of the document holder 16 serves as a reference surface, the “position above the document holder 16” signifies that the position is not only a position right above the reference surface but also a position above the reference surface in a vertical direction.

A stand 24 is arranged at the rear portion of the document holder 16 serving as the top surface of the apparatus body 12. The stand 24 extends generally vertically upward from the top surface of the apparatus body 12 and has an upper end portion that is bent over above the document holder 16. The photographing device 18 is mounted on the upper end portion of the stand 24.

An image former forming an image of an object placed on the document holder 16 is arranged between the discharge tray 14 and the document holder 16. In other words, the image former forming an image on a paper sheet to be discharged into the discharge tray 14 is arranged above the discharge tray 14.

The irradiation device 20 includes at least one light source, such as a light emitting diode (LED), for example, the light sources 20a, 20b, 20c, and 20d. The light sources 20a, 20b, 20c, and 20d are mounted on the stand 24. In other words, the light sources 20a, 20b, 20c, and 20d are arranged above the document holder 16.

Specifically, the light sources 20a and 20b are arranged close to the photographing device 18 of the stand 24 and on both side portions of the photographing device 18 in a manner such that the light sources 20a and 20b look downward. The light sources 20c and 20d are arranged close to the lower side of the operation panel 22 and on the lower side portions of the stand 24 in a manner such that the light sources 20c and 20d look in a slantly downward direction.

The light sources 20a and 20b and the light sources 20c and 20d are arranged at different height levels from the document holder 16. In other words, the light sources 20a, 20b, 20c, and 20d are different in terms of angles of light incident on the object and are thus configured to irradiate a document with light beams at different directions. In this way, the document may be more easily discriminated from the document holder 16.

The operation panel 22 includes a display screen and is configured to set the image forming apparatus 10. The operation panel 22 is mounted on the rear side of the apparatus body 12 and on the stand 24 between the document holder 16 and the photographing device 18.

A document transport device having a duplex reading function is mounted in the apparatus body 12 and below the top surface of the document holder 16. By sliding part of the top surface of the document holder 16, the document transport device may be used.

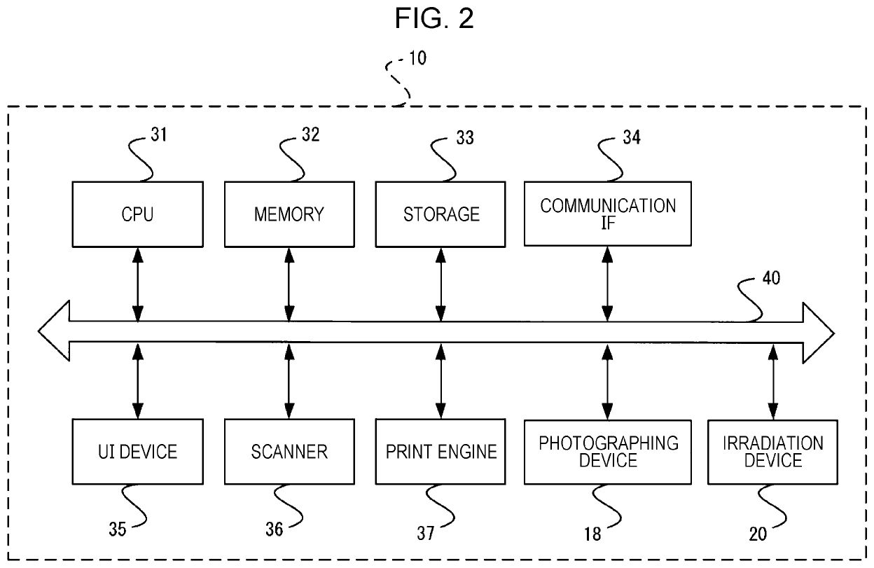

A hardware configuration of the image forming apparatus 10 of the exemplary embodiment is described below. FIG. 2 is a block diagram illustrating the hardware configuration of the image forming apparatus 10.

Referring to FIG. 2, the image forming apparatus 10 includes a central processing unit (CPU) 31, memory 32, storage 33, such as a hard disk drive, communication interface (IF) 34 that transmits data to and/or receives data from an external apparatus via a network, user interface (UI) device 35 including a keyboard and a touch panel or liquid-crystal display, scanner 36, print engine 37, photographing device 18, and irradiation device 20. These elements are interconnected to each other via a control bus 40.

The communication IF 34 transmits data to and/or receives data from an external apparatus. The UI device 35 receives an instruction from a user. The scanner 36 reads as image data a document placed on the image forming apparatus 10. The print engine 37 prints an image on a recording medium, such as a paper sheet, through charging, exposure, development, transfer, fixing and other operations.

The CPU 31 controls the operation of the image forming apparatus 10 by performing a predetermined process responsive to a control program stored on the memory 32 or storage 33. According to the exemplary embodiment, the CPU 31 reads the control program from the memory 32 or storage 33 and executes the read control program. Alternatively, the control program may be delivered in a recorded form on a computer readable recording medium. For example, the control program may be delivered in a recorded form on an optical disc, such as a compact disc read-only memory (CD-ROM) or digital versatile ROM (DVD-ROM), or a semiconductor memory such as a universal serial bus (USB) memory or memory card. The control program may be delivered from an external apparatus via a communication network connected to the communication IF 34.

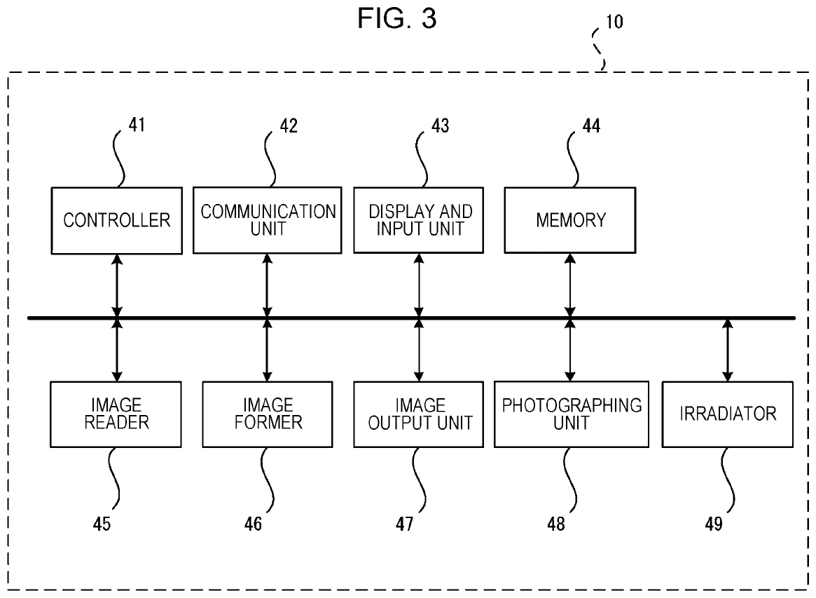

The functional configuration of the image forming apparatus 10 of the exemplary embodiment is described below. FIG. 3 is a functional block diagram illustrating the image forming apparatus 10.

Referring to FIG. 3, the image forming apparatus 10 includes a controller 41, communication unit 42, display and input unit 43, memory 44, image reader 45, image former 46, image output unit 47, photographing unit 48, and irradiator 49.

The controller 41 controls the whole operation of the image forming apparatus 10. For example, in response to reception of an instruction from a user, the controller 41 controls the photographing unit 48 photographing a document and the image output unit 47 outputting print data on a document image, and other units.

The communication unit 42 transmits data to and/or receives data from an external apparatus. The display and input unit 43, controlled by the controller 41, displays a variety of information on a display screen of the operation panel 22. The display and input unit 43 inputs a variety of information related to operations performed by the user on the operation panel 22. The display and input unit 43 is an example of a display in the exemplary embodiment of the disclosure. The memory 44 stores a variety of data, such as image data, created by the controller 41.

The image reader 45, controlled by the controller 41, performs a scan operation to read a variety of documents. The image former 46, controlled by the controller 41, forms an image to be output by the image output unit 47. The image output unit 47, controlled by the controller 41, outputs an image formed by the image former 46 onto a recording medium, such as a paper sheet.

The photographing unit 48, controlled by the controller 41, photographs a document placed on the document holder 16. The irradiator 49, controlled by the controller 41, irradiates the document placed on the document holder 16 with light.

The image forming apparatus 10 of the exemplary embodiment manages multiple document images as a single document by extracting each document image from an entire image resulting from photographing multiple documents placed on the document holder 16, setting page numbers on the document images, and arranging the document images in the order of page numbers.

In the page number setting, the controller 41 extracts position coordinates of each document image from an entire image resulting from photographing multiple documents; performs a first operation that extracts, from the document images included in the entire image, a first document image having two sides parallel with a direction of arrangement of the documents and having a first side of the two sides being a far side from a first coordinate axis, the first side having the shortest distance to the first coordinate axis, the first coordinate axis being in parallel with the direction of the arrangement of the documents set with respect to an origin of the entire image; performs a second operation that extracts, as an document image of the same group, a second document image overlapping an extension of the first side of the extracted first image document; and perform a third operation that sets a page number to each of the extracted document images of the same group in an order of closeness from near to far distance to the origin.

According to the exemplary embodiment, the controller 41 may exclude a document image having a page number out of the document images included in the entire image and iterate, until a document image without page number is no longer present, a fourth operation that sequentially performs the first operation, the second operation, and the third operation in order.

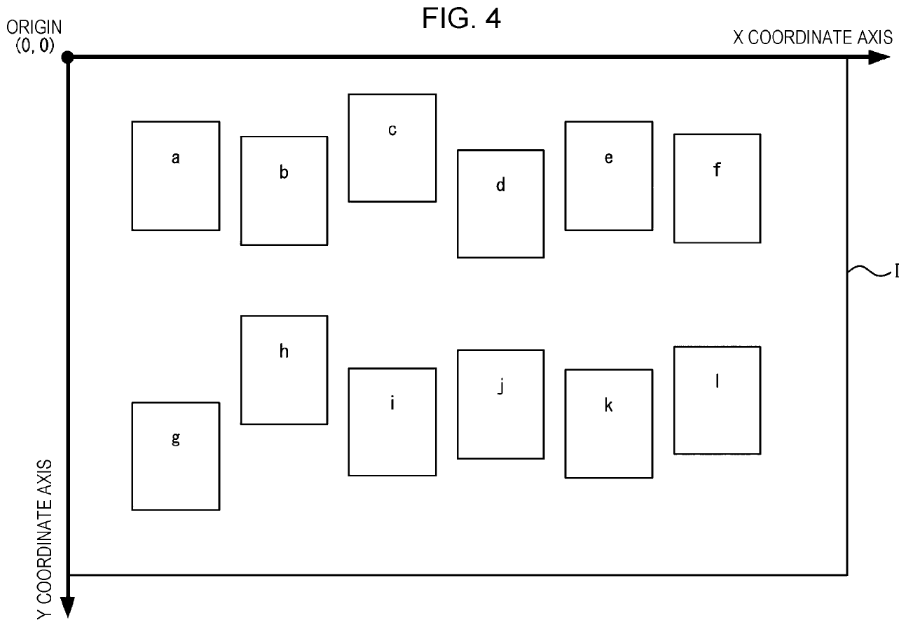

As described in detail below, the image forming apparatus 10 of the exemplary embodiment sets the page numbers onto the image documents in the entire image. FIGS. 4 through 13 illustrate operations that sets the page numbers on the document images.

According to the embodiment, the position of the origin of an entire image I is a top right position of the entire image I when a user faces a surface where documents are placed and a direction of the arranges of the documents is aligned with a horizontal direction of the entire image I.

For example, 12 documents including documents a through 1 may now be placed on the document holder 16 with 12 documents in two rows with the origin at the top left corner of the entire image I and the direction of the arrangement being the horizontal direction of the entire image I. In such a case, the entire image I of these documents photographed is illustrated in FIG. 4. Referring to FIG. 4, the entire image I includes 12 document images including a document image Ia of the document a through a document image Il of the document 1.

In part of the first operation, the controller 41 extracts, from the entire image I, position coordinates of the document images Ia through Il. The controller 41 then lists information on each document. The resulting list may be used to manage the number of document images included in the entire image I and the position coordinates of each document image.

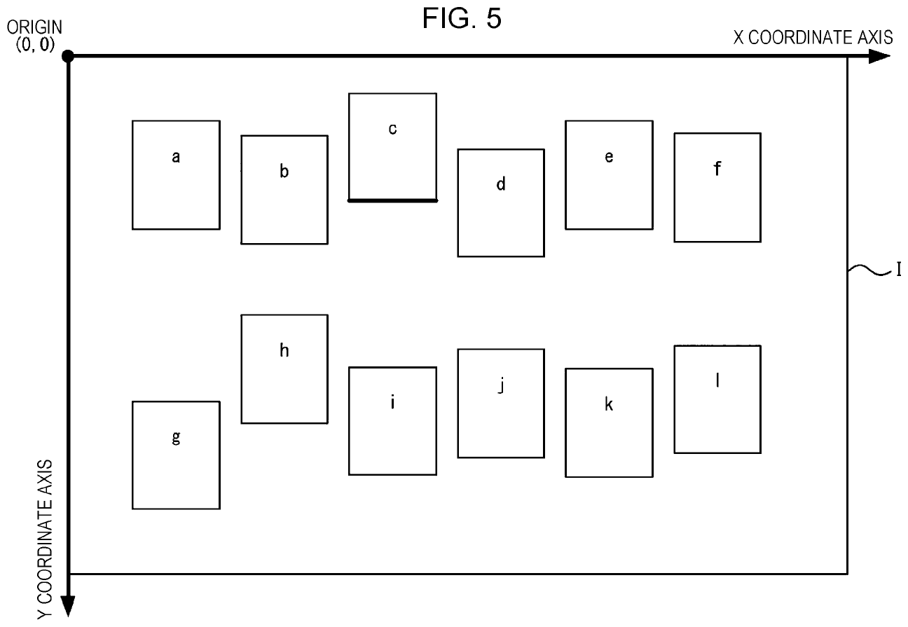

Referring to FIG. 5, in part of the first operation, the controller 41 extracts, from the document images Ia through Il included in the entire image I, the document image Ic that has two sides (an upper side and lower side herein) parallel with the direction of the arrangement of the documents with the one of the two sides that is the lower side farther from an X coordinate axis parallel with the direction of the arrangement set with respect to the origin of the entire image I and has the shortest distance to the X coordinate axis. The X coordinate axis is an example of a first coordinate axis of the exemplary embodiment of the disclosure. The lower side is an example of the first side of the exemplary embodiment of the disclosure.

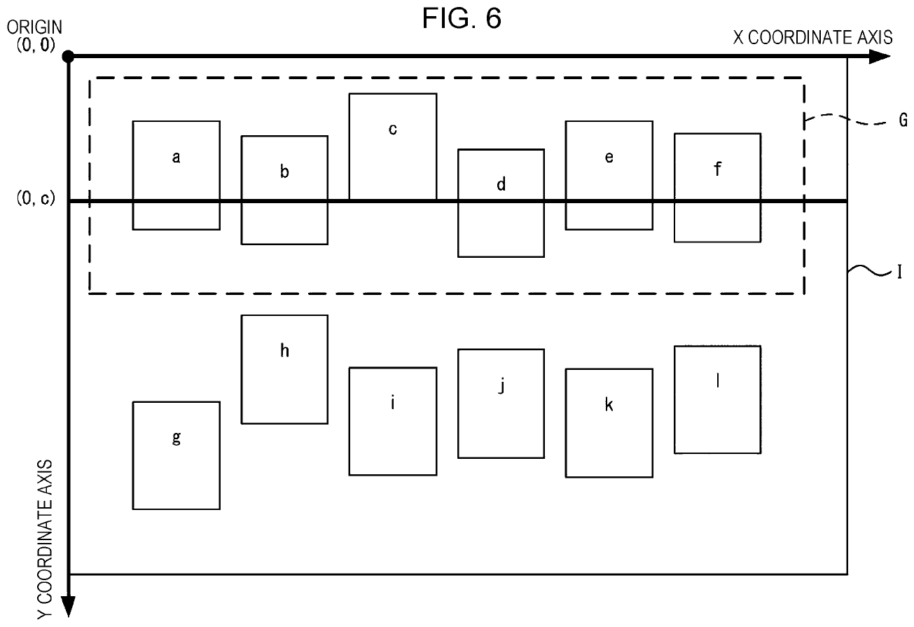

Referring to FIG. 6, the controller 41 performs the second operation that extracts as document images of the same group G the document images Ia, Ib, Id, Ie, and If that overlap the extension of the lower side of the extracted document image Ic extended in the direction of the arrangement.

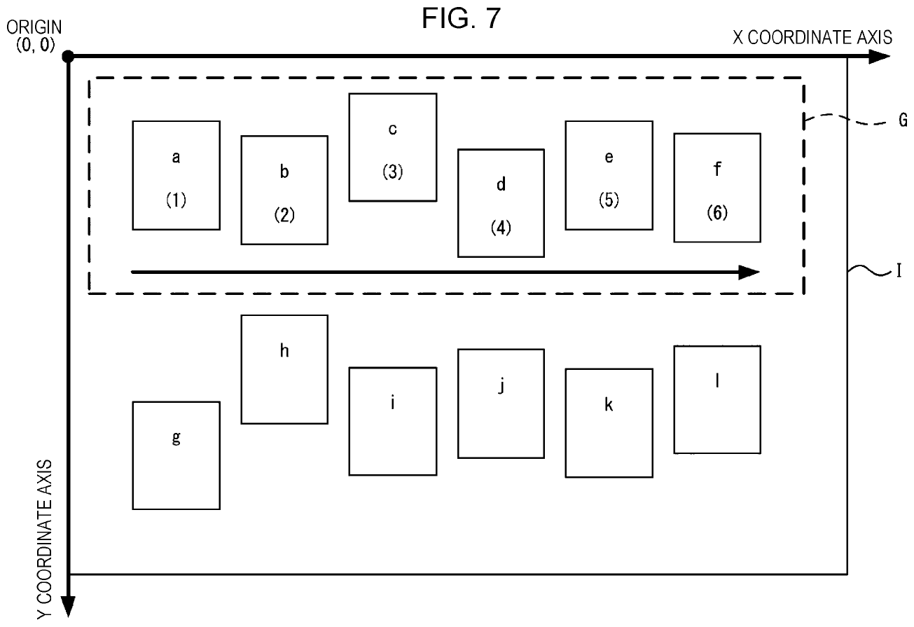

Referring to FIG. 7, the controller 41 performs the third operation that sets page numbers on the document images of the same extracted group in the order of closeness of from near to far distance from the origin. Page 1 is set on the document image Ta, page 2 is set on the document image Tb, page 3 is set on the document image Ic, page 4 is set on the document image Id, page 5 is set on the document image Ie, and page 6 is set on the document image If.

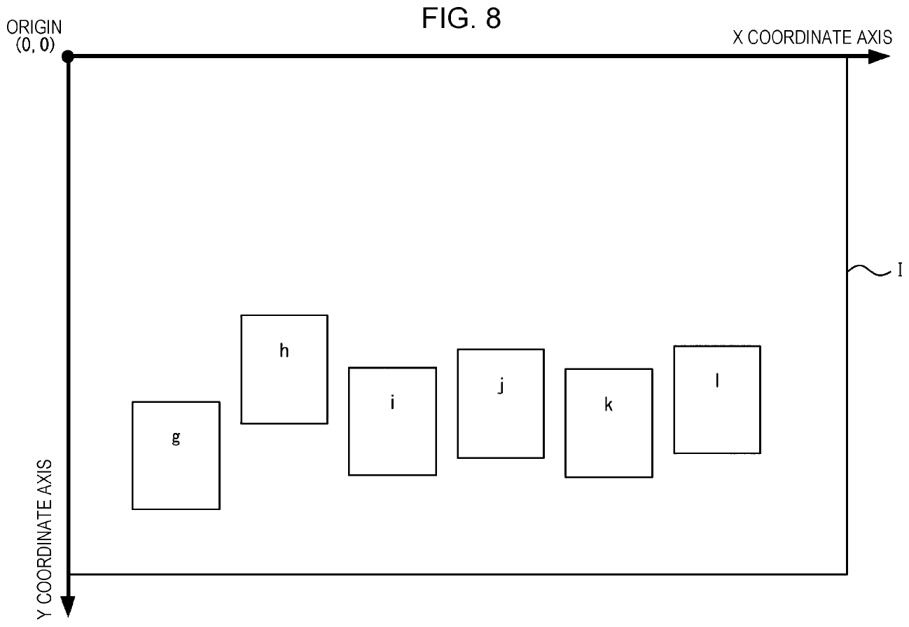

Referring to FIG. 8, the controller 41 performs part of the fourth operation that excludes the document image Ta to the document image If having page number set thereon from the document images Ta through Il included in the entire image I. The controller 41 further deletes, from the list, information on the document images having the page numbers set thereon.

The controller 41 performs sequentially the first operation, second operation, and third operation in this order as part of the forth operation.

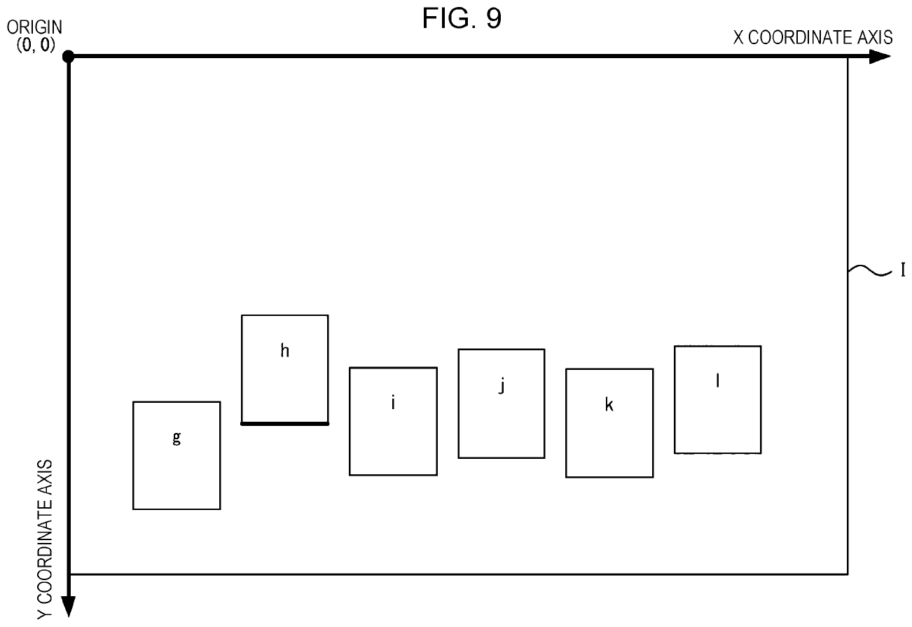

Specifically, referring to FIG. 9, the controller 41 performs the first operation by extracting, from the remaining document images Ig through Il included in the entire image I, the document image Ih that has two sides (the upper side and lower side herein) parallel with the direction of the arrangement of the documents with the one of the two sides that is the lower side farther from an X coordinate axis parallel with the direction of the arrangement set with respect to the origin of the entire image I and has the shortest distance to the X coordinate axis.

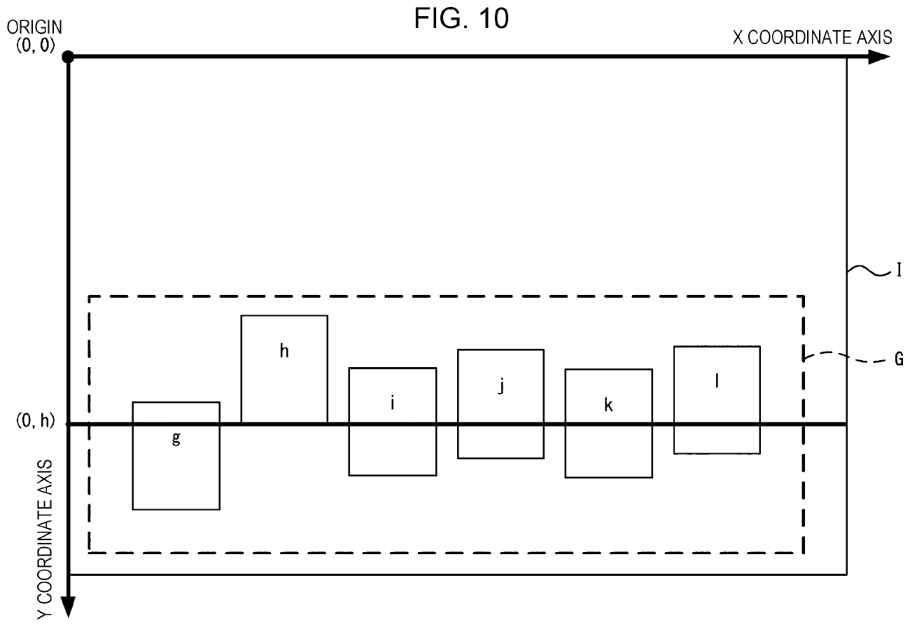

Referring to FIG. 10, the controller 41 performs the second operation that extracts as document images of the same group G of the other document images Ig, Ii, Ij, Ik, and Il that overlap the extension of the lower side of the extracted document image Ih extended in the direction of the arrangement.

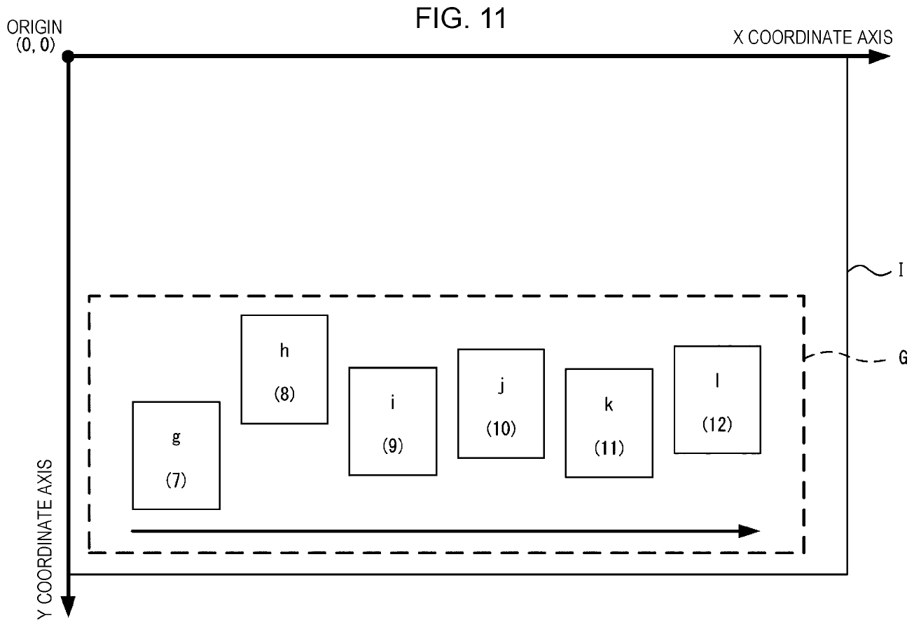

Referring to FIG. 11, the controller 41 performs the third operation that sets page numbers on the document images of the same extracted group in the order of closeness of from near to far distance from the origin. Page 7 is set on the document image Ig, page 8 is set the document image Ih, page 9 is set on the document image Ii, page 10 is set on the document image Ij, page 11 is set on the document image Ik, and page 12 is set on the document image Il.

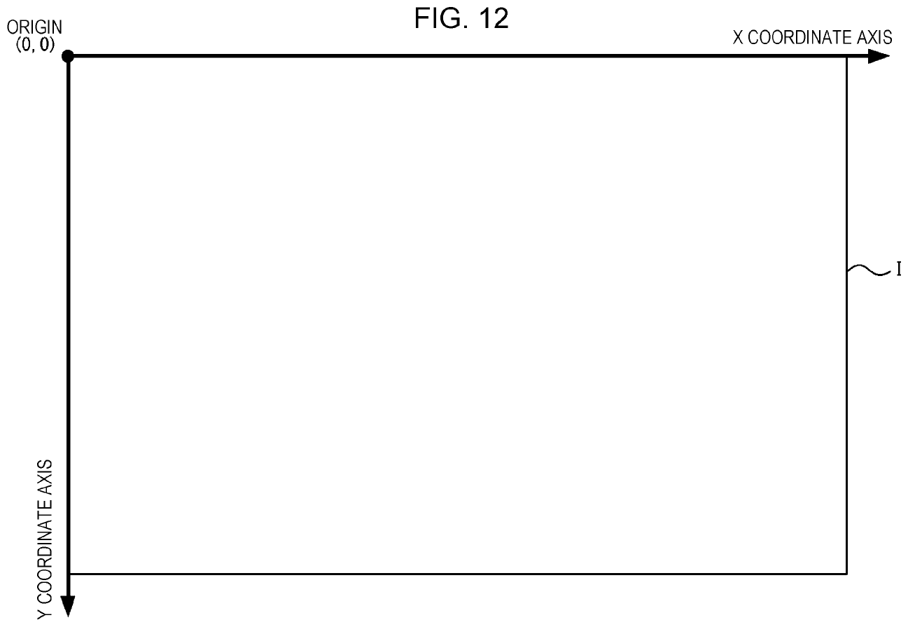

The controller 41 iterates the fourth operation until the document images without page numbers are no longer present. Specifically, the fourth operation is iterated until information of the document images registered in the list is no longer present. According to the exemplary embodiment, referring to FIG. 12, since a document image without page number is no longer present after setting the page number to the document image Il, the process thus ends.

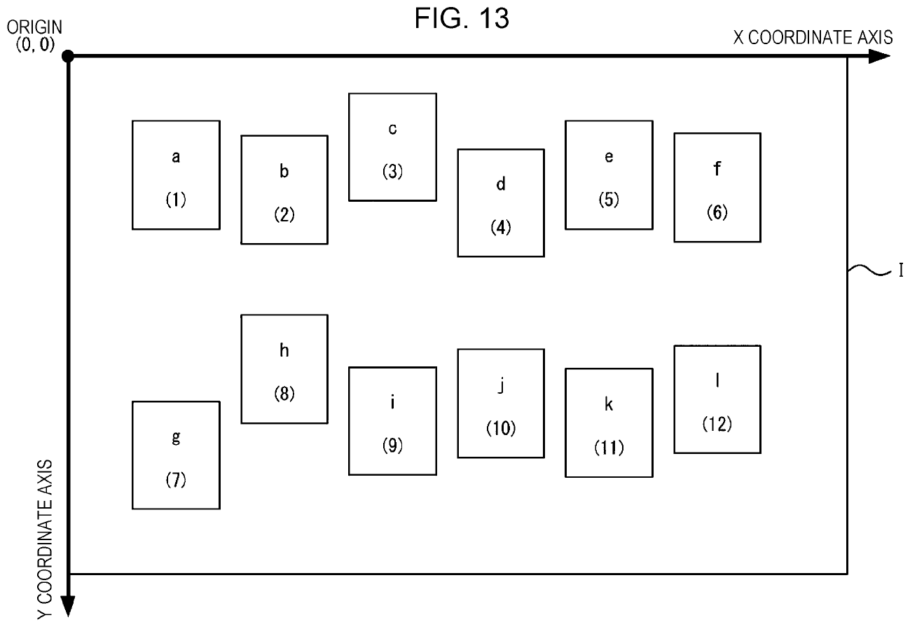

Even when multiple documents are randomly placed on the document holder 16, the process described above sets correctly the pages onto all the document images Ia through Il in a set direction of the arrangement as illustrated in FIG. 13.

The controller 41 may create a document by arranging the document images in the set order of page numbers after setting the page numbers on all the document images Ia through Il.

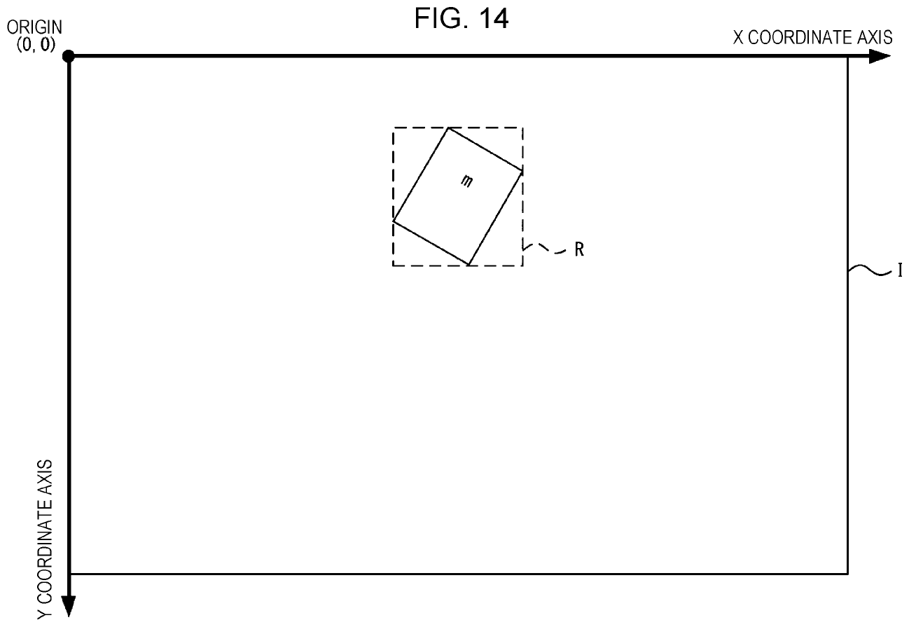

According to the exemplary embodiment, referring to FIG. 14, the controller 41 may regard a document image Im as being a rectangle R having sides parallel with the direction of the arrangement even when the document image Im is rectangular but has no sides parallel with the direction of the arrangement.

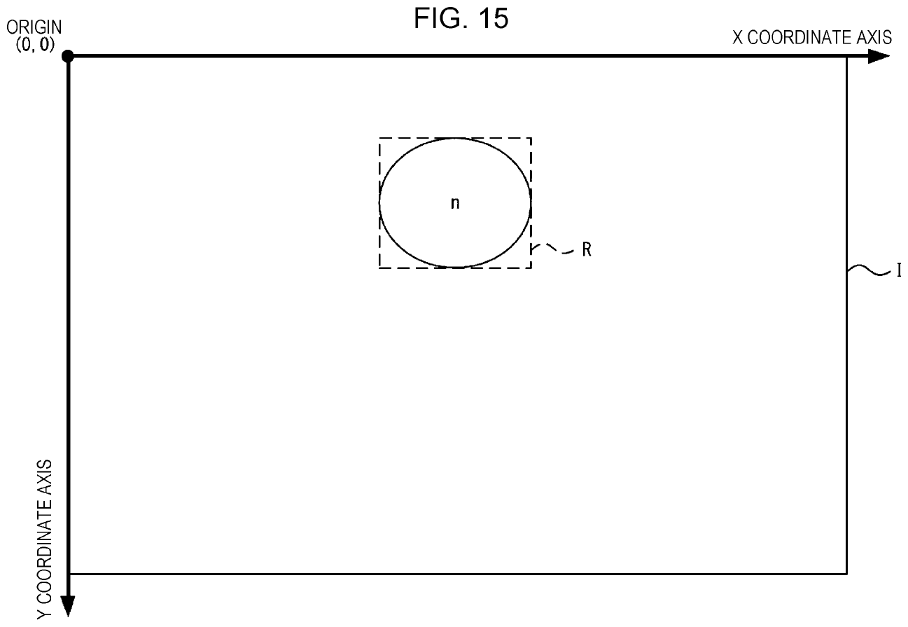

Referring to FIG. 15, if a document image In is not rectangular, the controller 41 may regard the document image In as being a rectangle R that is in contact with a document image and has sides parallel with the direction of the arrangement.

In response to an instruction from a user, the controller 41 may be configured to modify at least one of the position of the origin of the entire image I or the direction of the arrangement.

In such a case, in response to the instruction from the user, the controller 41 may be configured to: in response to the instruction from the user, modify the position of the origin of the entire image I to a first setting that sets, when the user faces a surface on which the document is placed, the position of the origin of the entire image I to a top left position of the entire image I and the direction of the arrangement to a horizontal direction of the entire image I; modify the position of the origin of the entire image I to a second setting that sets, when the user faces the surface on which the document is placed, the position of the origin of the entire image I to the top left position of the entire image I and the direction of the arrangement to a vertical direction of the entire image I; modify the position of the origin of the entire image I to a third setting that sets, when the user faces the surface on which the document is placed, the position of the origin of the entire image I to a top right position of the entire image I and the direction of the arrangement to the horizontal direction of the entire image I; or modify the position of the origin of the entire image I to a fourth setting that sets, when the user faces the surface on which the document is placed, the position of the origin of the entire image I to the top right position of the entire image I and the direction of the arrangement to the vertical direction of the entire image I.

As described above, the process of setting the page numbers on the document images is performed in the entire image I in the first setting where page setting starts at the position of the origin set to the top left position with the direction of the arrangement set to the horizontal direction.

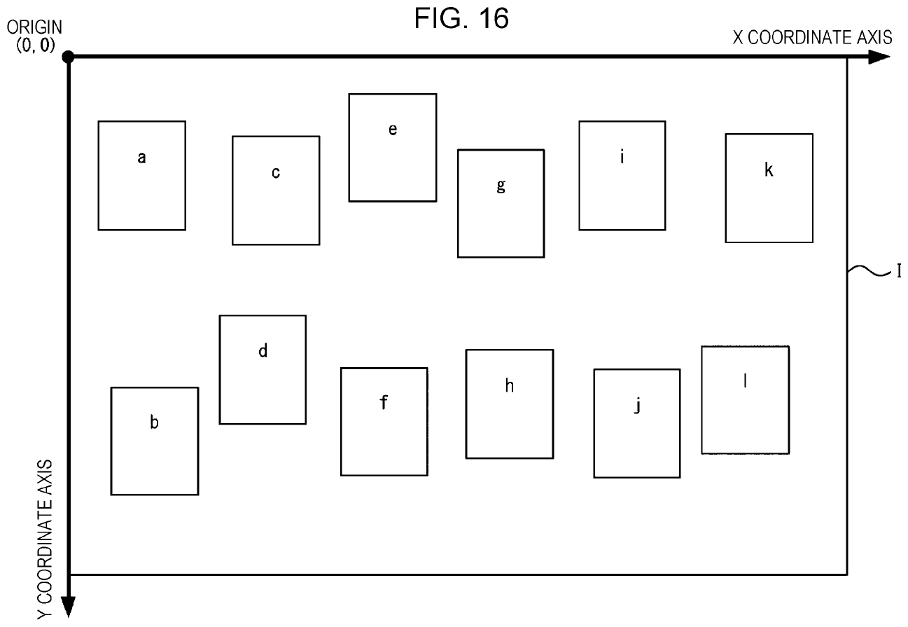

The process of setting the page numbers on the document images is performed in the entire image I in the second setting where the page setting starts at the position of the origin set to the top left position with the direction of the arrangement set to the vertical direction. The process is described in detail. FIGS. 16 through 25 describe the process of setting the page numbers on the document images in the entire image I.

For example, 12 sheets of documents from document a to document 1 are placed in two rows and six columns on the document holder 16 with the position of the origin set to the top left position of the entire image I and the direction of the arrangement set to the vertical direction. FIG. 16 illustrates the entire image I when all these documents are photographed.

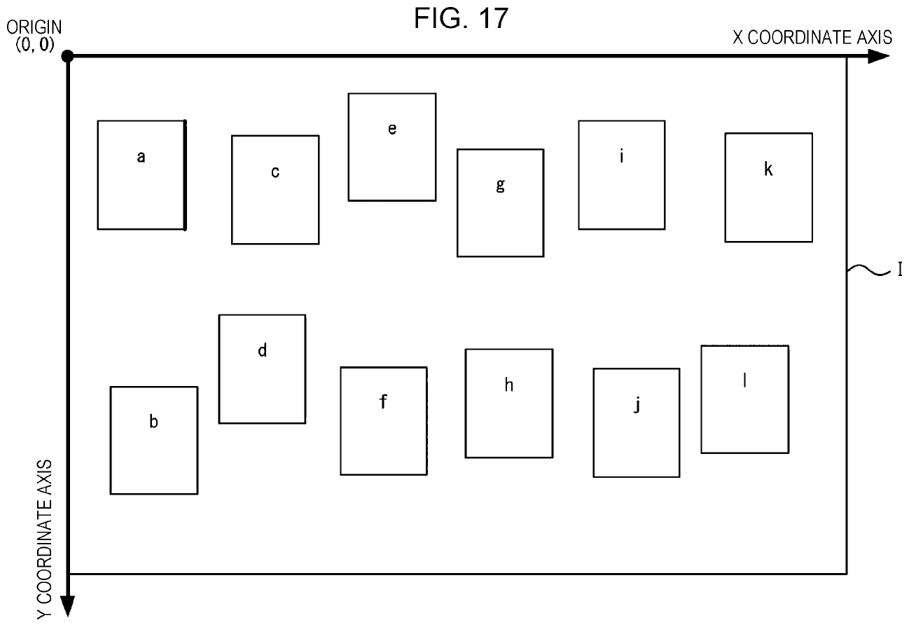

In part of the first operation, the controller 41 extracts coordinate positions of the document images Ia through Il from the entire image I. The controller 41 then lists information on each document image. Referring to FIG. 17, in the part of the first operation, the controller 41 extracts from the document images Ia through Il included in the entire image I the document image Ia that has two sides (a left side and right side herein) parallel with the direction of the arrangement of the documents with the one of the two sides that is the right side farther from an Y coordinate axis parallel with the direction of the arrangement set with respect to the origin of the entire image I and has the shortest distance to the Y coordinate axis. The Y coordinate axis is an example of a first coordinate axis of the exemplary embodiment of the disclosure. The right side is an example of the first side of the exemplary embodiment of the disclosure.

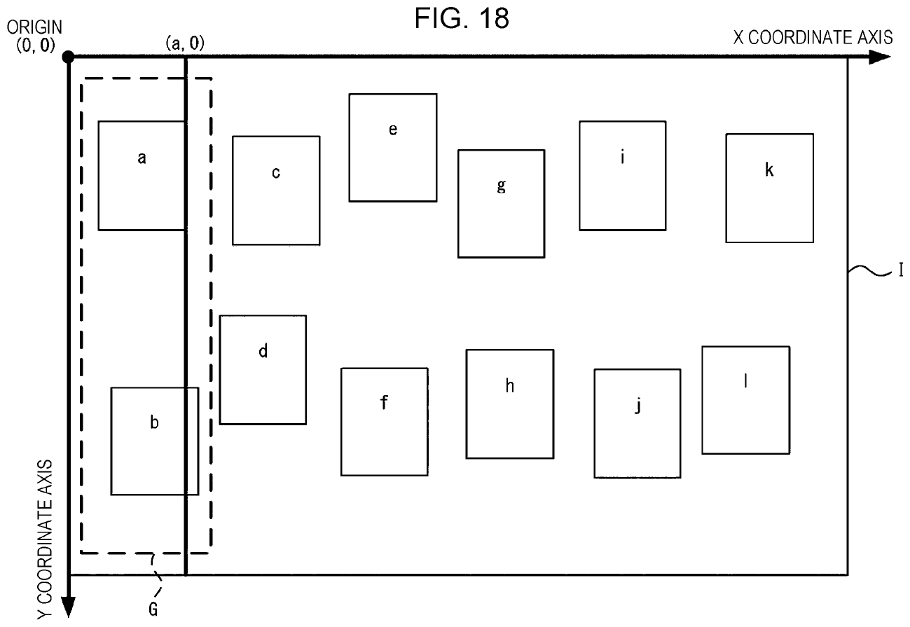

Referring to FIG. 18, the controller 41 performs the second operation that extracts as a document image of the same group G another document image Ib that overlaps the vertical extension of the right side of the document image Ia extended in the direction of the arrangement.

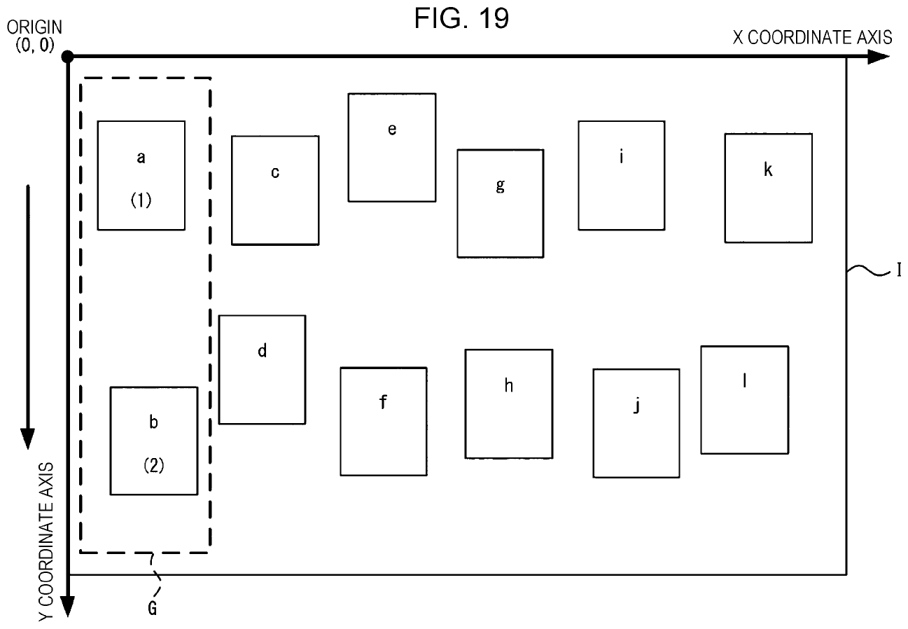

Referring to FIG. 19, the controller 41 performs the third operation that sets page numbers on the document images of the same extracted group G in in the order of closeness of from near to far distance from the origin. Page 1 is set on the document image Ia, and page 2 is set the document image Ib.

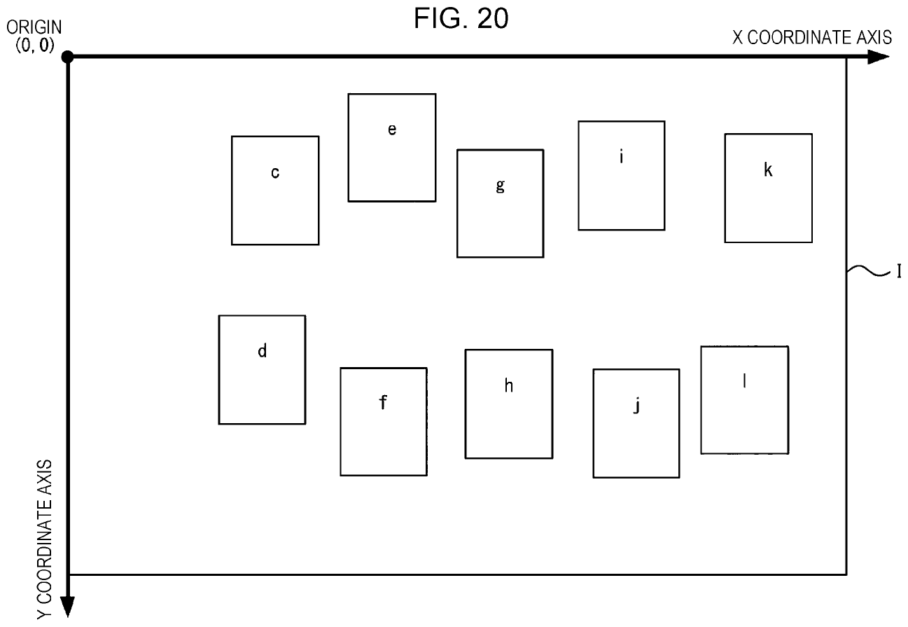

Referring to FIG. 20, the controller 41 performs part of the fourth operation that excludes the document image Ta and the document image Tb having page numbers set thereon from the document images Ta through Il included in the entire image I. The controller 41 further deletes, from the list, information on the document images having the page numbers set thereon.

The controller 41 performs sequentially the first operation, second operation, and third operation in this order as part of the forth operation.

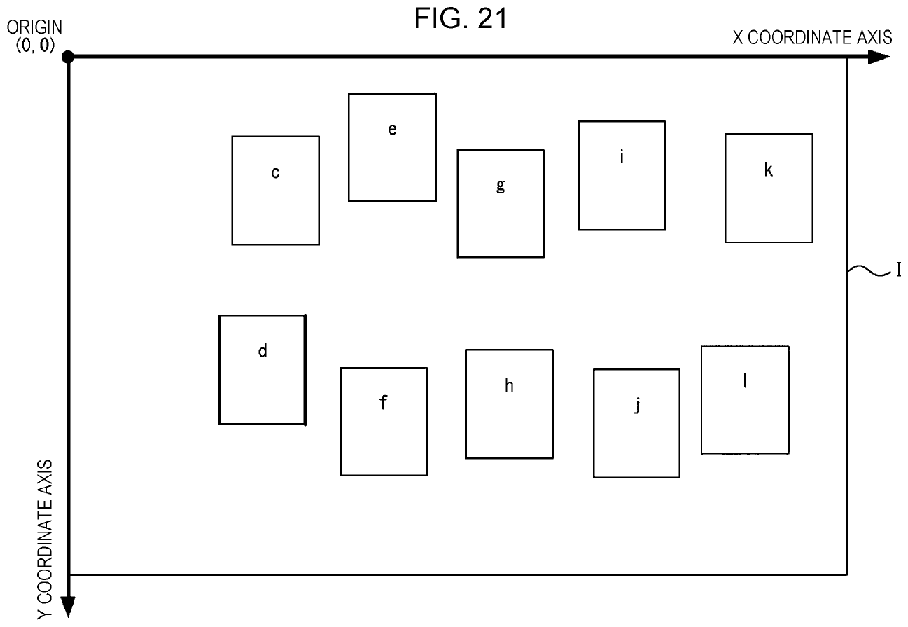

Specifically, referring to FIG. 21, the controller 41 performs the first operation by extracting from the remaining document images Ic through Il included in the entire image I the document image Id that has two sides (a left side and right side herein) parallel with the direction of the arrangement of the documents with the one of the two sides that is the right side farther from the Y coordinate axis parallel with the direction of the arrangement set with respect to the origin of the entire image I and has the shortest distance to the Y coordinate axis.

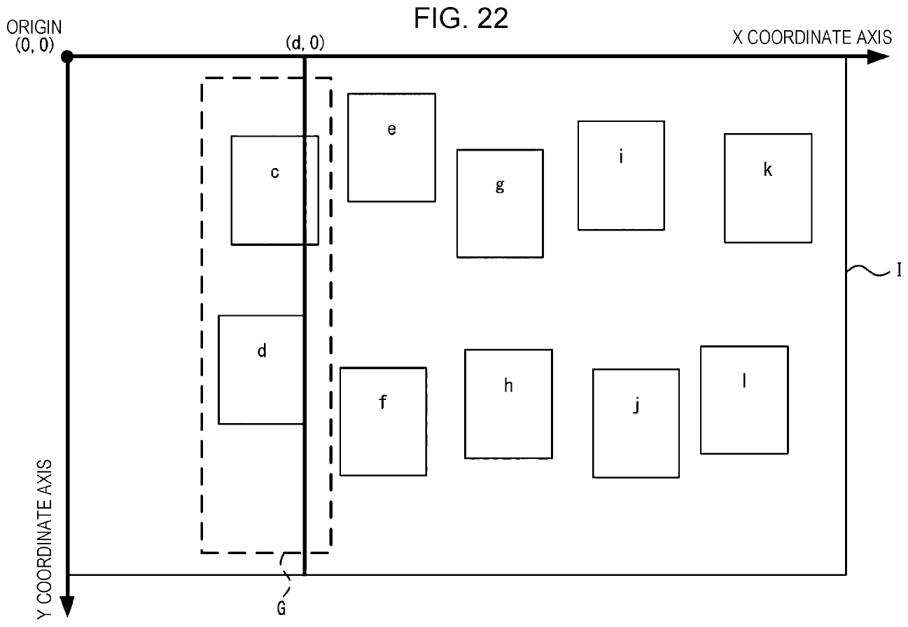

Referring to FIG. 22, the controller 41 performs the second operation that extracts as a document image of the same group G another document image Ic that overlaps the vertical extension of the right side of the extracted document image Id extended in the direction of the arrangement.

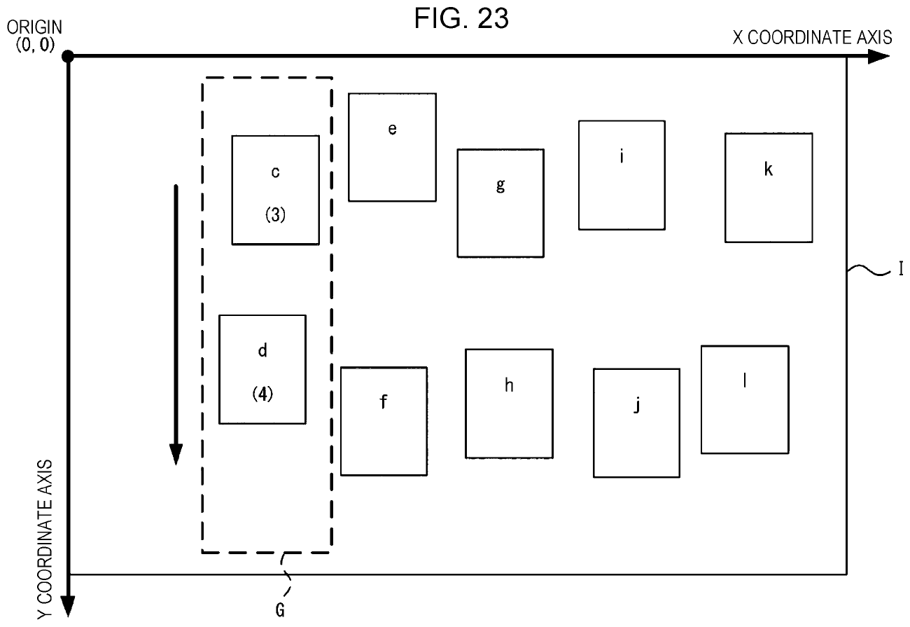

Referring to FIG. 23, the controller 41 performs the third operation that sets page numbers on the document images of the same extracted group G in in the order of closeness of from near to far distance from the origin. For example, page 3 is set on the document image Ic, and page 4 is set the document image Id.

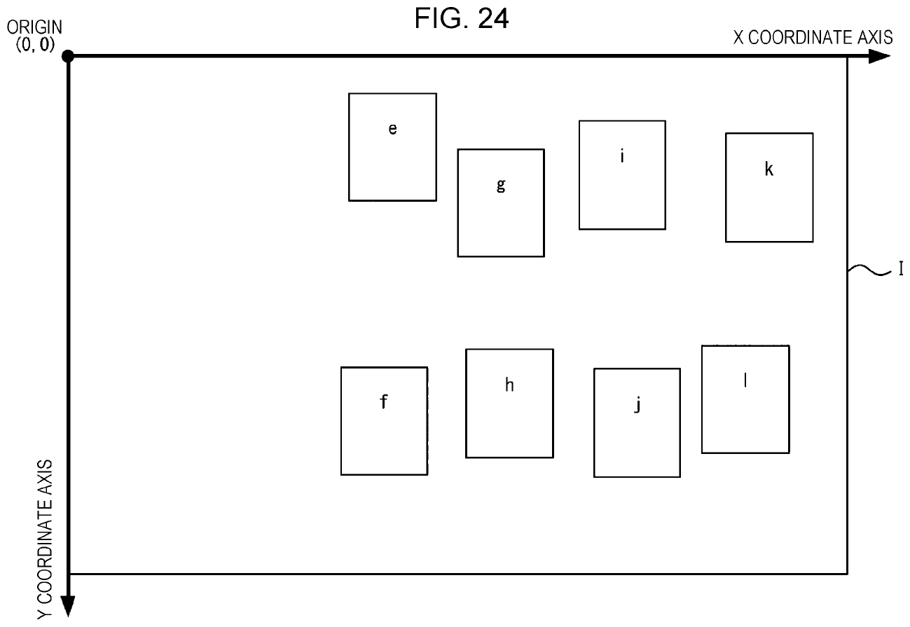

The controller 41 iterates the fourth operation until the document images without page numbers are no long present, namely, until the information on the document images registered in the list is no longer present. Referring to FIG. 24, document images Ie through Il without page numbers are left remained when the page number is set on the document image Id. The controller 41 thus ends the process after iterating the fourth operation until the document images without page numbers are no longer present.

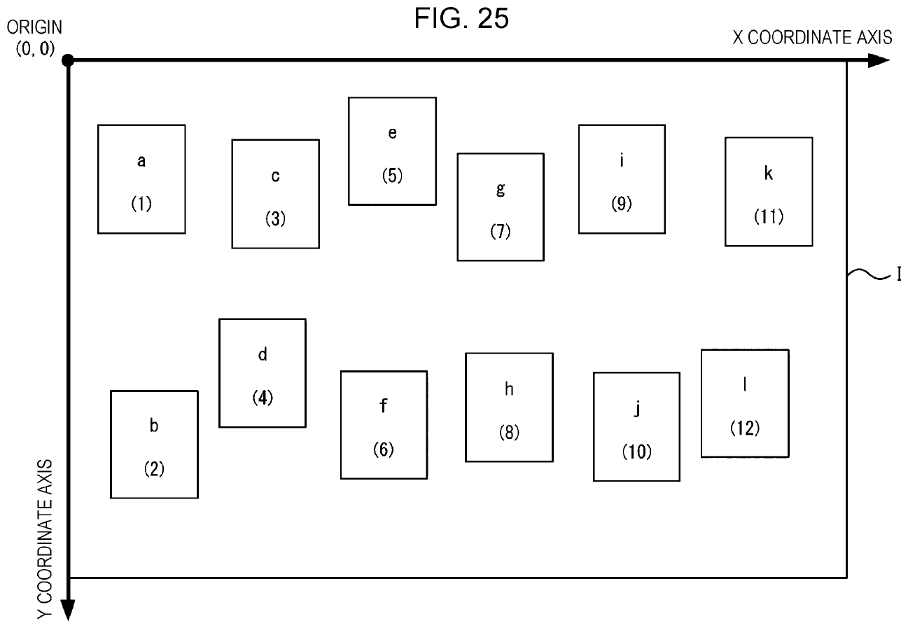

Even when the multiple documents are randomly placed on the document holder 16, the process described above sets correctly the page numbers on all the document images Ia through Il in the set direction of the arrangement as illustrated in FIG. 25.

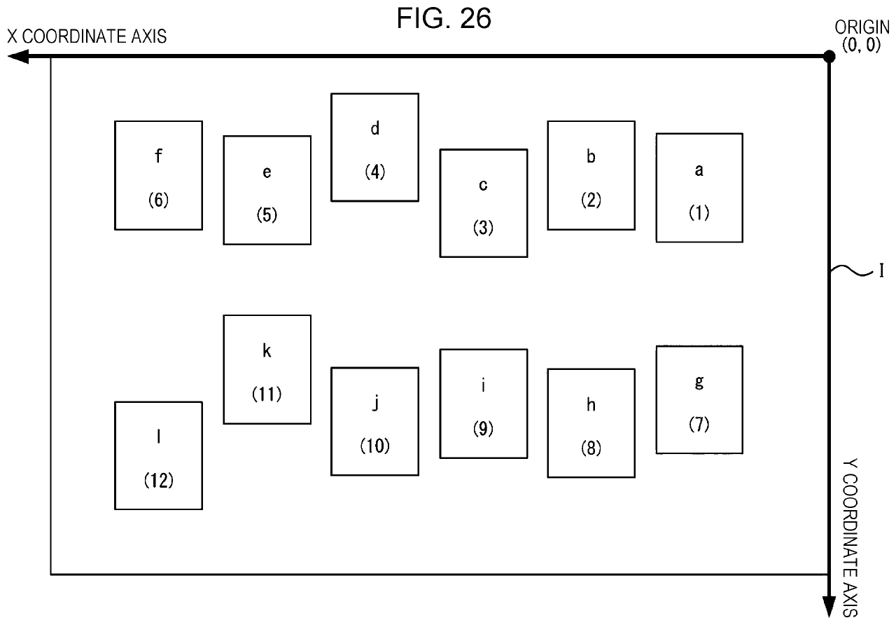

The process of setting the page numbers on the document images is performed in the entire image I in the third setting where the page setting starts at the position of the origin set to the top right position with the direction of the arrangement set to the horizontal direction. The process is described in detail. FIG. 26 illustrates a setting configuration of the entire image I and page numbers in the third setting.

When 12 sheets of documents from document a to document 1 are placed in two rows and six columns on the document holder 16 with the origin set to the top right position of the entire image I and the direction of the arrangement set to the horizontal direction, the entire image I resulting from photographing these documents is illustrated in FIG. 26. It is noted that FIG. 26 also illustrates the page numbers.

The process of setting the page numbers in the third setting is substantially identical to the process in the first setting. Only the difference between the first setting and the third setting is that, in the third setting, the page setting in the order of closeness of from near to far distance from the origin starts at the rightmost one of the extracted document images in the same group.

Referring to FIG. 26, the page numbers are set starting at the top right position in the horizontal direction in the third setting.

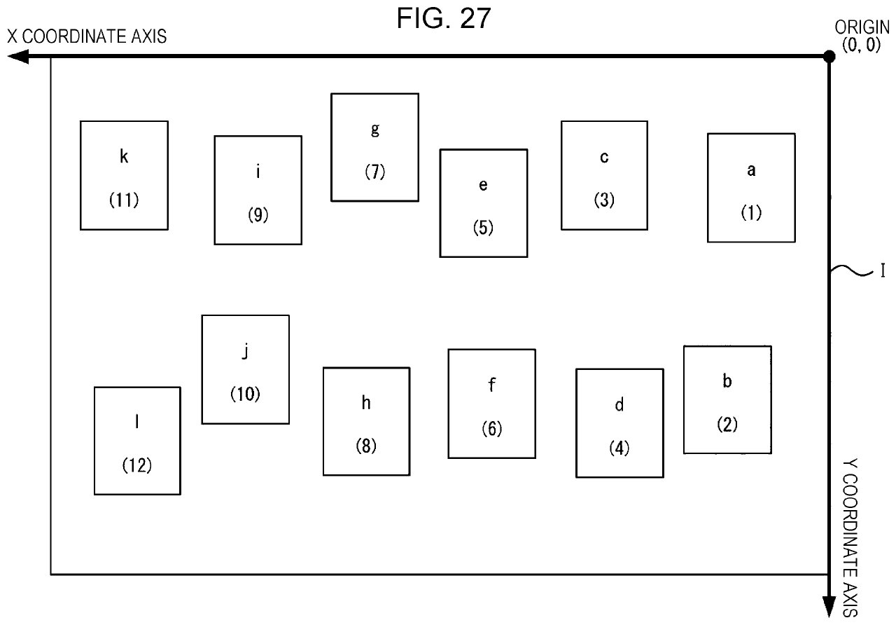

The process of setting the page numbers on the document images is performed in the entire image I in the fourth setting where the page setting starts at the position of the origin set to the top right position with the direction of the arrangement set to the vertical direction. The process is described in detail. FIG. 27 illustrates a setting configuration of the entire image I and page numbers in the fourth setting.

When 12 sheets of documents from document a to document 1 are placed in six columns on the document holder 16 with the origin set to the top right position of the entire image I and the direction of the arrangement set to the vertical direction, the entire image I resulting from photographing these documents is illustrated in FIG. 27. It is noted that FIG. 27 also illustrates the page numbers.

The process of setting the page numbers in the fourth setting is substantially identical to the process in the second setting. Only the difference between the second setting and the fourth setting is that, in the fourth setting, the page setting in in the order of closeness of from near to far distance from the origin starts at the rightmost one of the extracted document images in the same group G.

Referring to FIG. 27, the page numbers are set starting at the top right position in the vertical direction in the fourth setting.

Referring to FIG. 13 and other figures, the controller 41 may display the page numbers together with the document images in the entire image I.

In such a case, the controller 41 may move the document images in the entire image I in response to an instruction from the user and reset the page numbers of the document images in accordance with the movement of the document images.

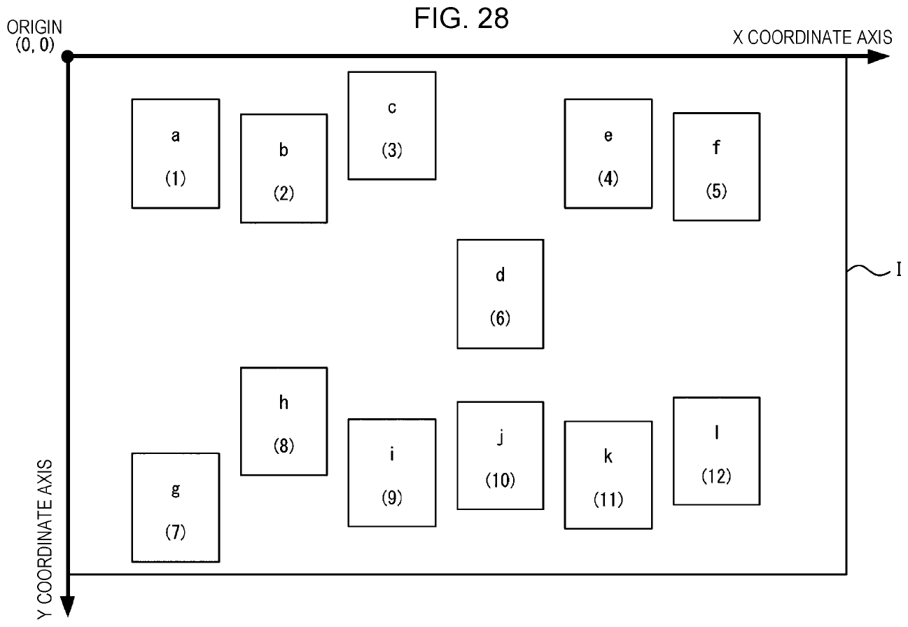

As illustrated in FIG. 28, the user may now place the 12 sheets of the document a to the document 1 on the document holder 16 in two rows with the origin set to the top left position of the entire image I and the direction of the arrangement set to the horizontal direction.

Since the document d is greatly displaced from the documents a, b, c, e, and f, the controller 41 determines that the 12 sheets are placed in three rows and sets the page numbers as illustrated in FIG. 28.

Specifically, page 1 is set on the document image Ia, page 2 is set on the document image Ib, page 3 is set on the document image Ic, page 4 is set on the document image Ie, and page 5 is set on the document image If. Page 6 is set on the document image Id. Page 7 is set on the document image Ig, page 8 is set on the document image Ih, page 9 is set on the document image Ii, page 10 is set on the document image Ij, page 11 is set on the document image Ik, and page 12 is set on the document image Il.

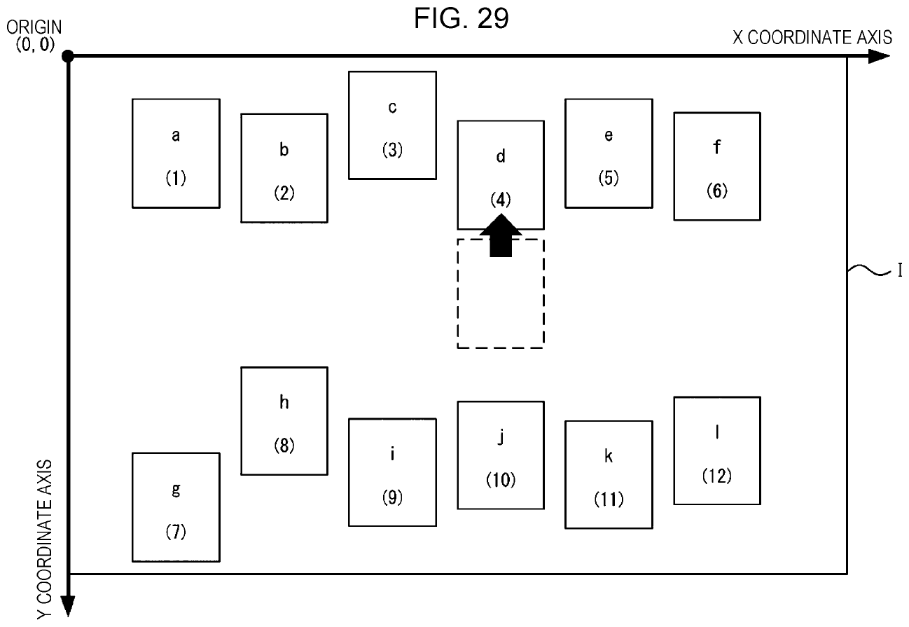

Referring to FIG. 29, the document image Id may now be moved upward in the Y coordinate axis direction in response to an instruction such that the document image Id is generally aligned with the document a and other documents. The movement instruction of each document image in the entire image I may be obtained in any way. For example, the movement instruction may be obtained in a manner such that the entire image I is displayed on the operation panel 22 serving as the display and input unit 43 and the movement instruction of each document image is received on the operation panel 22 from the user.

When the movement of the document image Id is detected, the controller 41 resets the page numbers by performing again the setting process of the page numbers of the document images. As a result, as illustrated in FIG. 29, page 1 is set on the document image Ia, page 2 is set on the document image Ib, page 3 is set on the document image Ic, page 4 is set on the document image Id, and page 5 is set on the document image Ie, and page 6 is set on the document image If.

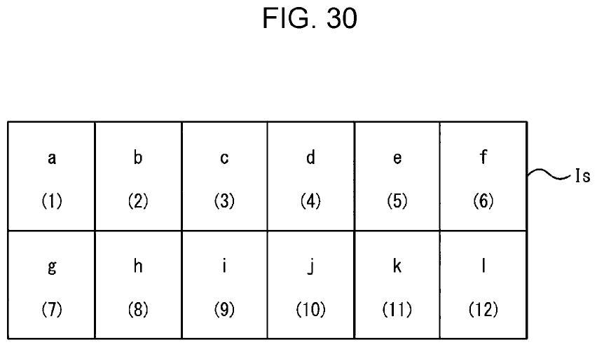

In one operation example as illustrated in FIG. 30, the controller 41 may display a set Is of images that have the page numbers and are arranged in the order of page numbers. The “set of images that have the page numbers and are arranged in the order of page numbers” signifies a single image that is formed by arranging the document images in the order of page numbers and may be any type of image that is created in this way.

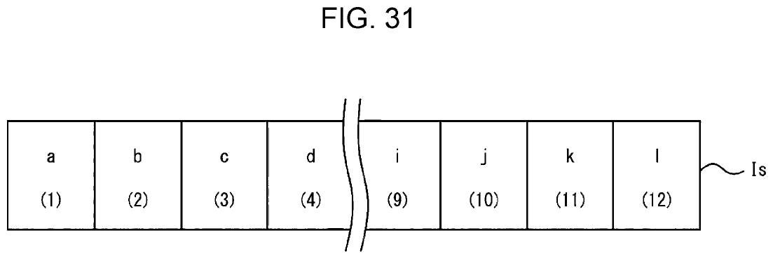

Referring to FIG. 30, the number of rows and columns in the image set Is may match the number rows and columns of a placement form of the documents. The image set Is may be formed by arranging the document images in a single row in the order of page numbers as illustrated in FIG. 31.

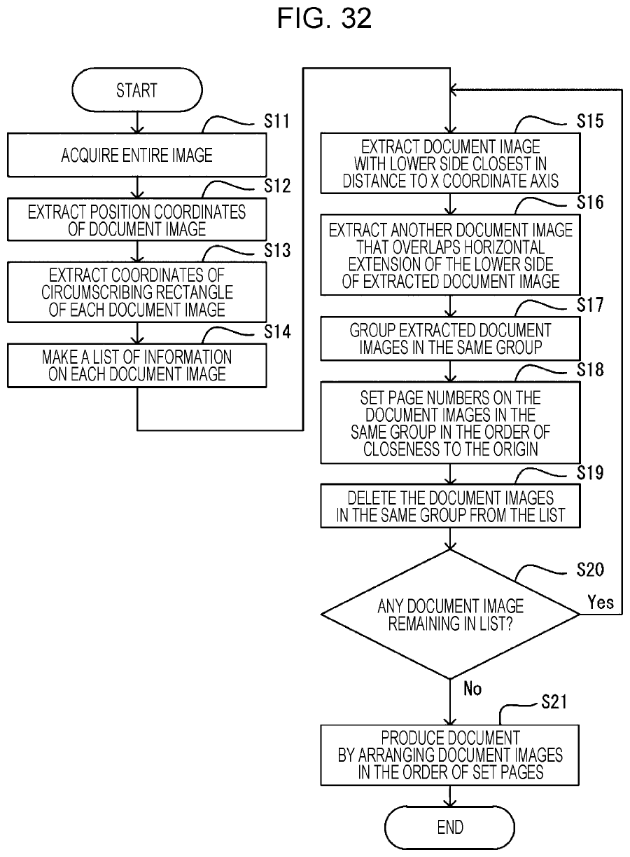

The process of setting the page numbers on the document images in the entire image I is described with reference to a flowchart illustrated in FIG. 32. The top left position of the entire image I serves as the origin of the entire image I when the user faces the surface where the document images are placed and the horizontal direction of the entire image serves as the direction of the arrangement.

In step S11, the controller 41 acquires the entire image I by photographing multiple documents placed in a matrix of rows and columns.

In step S12, the controller 41 extracts position coordinates of each document image from the entire image.

In step S13, if a document image is rectangular without sides parallel with the direction of the arrangement or is not rectangular at all, the controller 41 extracts position coordinates of a rectangle (namely, a circumscribing rectangle) that is in contact with the perimeter of the document image and has sides parallel with the direction of the arrangement.

In step S14, the controller 41 lists information on each document image.

In step S15, the controller 41 extracts a document image that has two sides (an upper side and lower side herein) parallel with the direction of the arrangement of the documents with the one of the two sides that is the lower side farther from an X coordinate axis parallel with the direction of the arrangement set with respect to the origin of the entire image and has the shortest distance to the X coordinate axis.

The controller 41 extracts in step S16 another document image that overlaps the horizontal extension of the lower side of the extracted document image and sets in step S17 the extracted document image as a document image of the same group.

In step S18, the controller 41 sets the page numbers on the document images of the same group in in the order of closeness of from near to far distance from the origin.

In step S19, the controller 41 deletes the document images in the same group from the list, namely, the document images with the page numbers.

In step S20, the controller 41 determines whether a document image is left remained in the list.

If the controller 41 determines in step S20 that a document image is left remained in the list, the controller 41 returns to step S15 to iterate steps from S15 to S19.

If the controller 41 determines in step S20 that no document is left remained, the controller 41 arranges in step S21 the document images in the set order of page numbers, creates a document and ends the process.

### Modifications

The image forming apparatus as the exemplary embodiment of the disclosure has been described. The disclosure is not limited to the exemplary embodiment and may be modified and changed as appropriate.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

According to the exemplary embodiment, the disclosure is applied to the multi-function apparatus as the image forming apparatus. The disclosure is not limited to this multi-function apparatus. The disclosure may be applied to another image forming apparatus, such as a scanner.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image processing apparatus comprising:
a processor configured to:
   extract position coordinates of each document image from an entire image resulting from photographing multiple documents;
   perform a first operation that extracts, from the document images included in the entire image, a first document image having two sides parallel with a direction of arrangement of the documents and having a first side of the two sides being a far side from a first coordinate axis, the first side having the shortest distance to the first coordinate axis, the first coordinate axis being in parallel with the direction of the arrangement of the documents set with respect to an origin of the entire image;
   perform a second operation that extracts, as an document image of a same group, a second document image overlapping an extension of the first side of the extracted first document image, the extension extending in the direction of the arrangement; and
   perform a third operation that sets a page number on each of the extracted document images of the same group in an order of closeness from near to far distance to the origin.
      (((2)))

In the image processing apparatus according to (((1))), the processor is configured to exclude a document image having a page number out of the document images included in the entire image and iterate, until a document image without page number is no longer present, a fourth operation that sequentially performs the first operation, the second operation, and the third operation in order.

(((3)))

In the image processing apparatus according to one of (((1))) and (((2))), the processor is configured to, if an document image is rectangular with no side parallel with the direction of the arrangement or the document image is not rectangular, regard a shape of the document image as a rectangle that is in contact with a perimeter of the document image and has sides parallel with the direction of the arrangement.

(((4)))

In the image processing apparatus according to any one of (((1))) through (((3))), the processor is configured to modify at least one of a position of the origin of the entire image or the direction of the arrangement in response to an instruction from a user.

(((5)))

In the image processing apparatus according to (((4))), the processor is configured to: in response to the instruction from the user,
modify the position of the origin of the entire image to a first setting that sets, when the user faces a surface on which the document is placed, the position of the origin of the entire image to a top left position of the entire image and the direction of the arrangement to a horizontal direction of the entire image;
modify the position of the origin of the entire image to a second setting that sets, when the user faces the surface on which the document is placed, the position of the origin of the entire image to the top left position of the entire image and the direction of the arrangement to a vertical direction of the entire image;
modify the position of the origin of the entire image to a third setting that sets, when the user faces the surface on which the document is placed, the position of the origin of the entire image to a top right position of the entire image and the direction of the arrangement to the horizontal direction of the entire image; or
modify the position of the origin of the entire image to a fourth setting that sets, when the user faces the surface on which the document is placed, the position of the origin of the entire image to the top right position of the entire image and the direction of the arrangement to the vertical direction of the entire image.
   (((6)))

In the image processing apparatus according to any one of (((1))) through (((5))), the processor is configured to display together with each of the document images a page number set on the document image in the entire image.

(((7)))

In the image processing apparatus according to (((6))), the processor is configured to:
be enabled to move each of the document images in the entire image in response to an instruction from a user; and
reset the page number of each of the document images in response to a movement of the document image.
   (((8)))

In the image processing apparatus according to any one of (((1))) through (((5))), the processor is configured to display the document images arranged in an order of page numbers set on the document images.

(((9)))

A program causing a computer to execute a process for processing information, the process including:
extracting position coordinates of each document image from an entire image resulting from photographing multiple documents;
performing a first operation that extracts, from the document images included in the entire image, a first document image having two sides parallel with a direction of arrangement of the documents and having a first side of the two sides being a far side from a first coordinate axis, the first side having the shortest distance to the first coordinate axis, the first coordinate axis being in parallel with the direction of the arrangement of the documents set with respect to an origin of the entire image;
performing a second operation that extracts, as an document image of a same group, a second document image overlapping an extension of the first side of the extracted first document image, the extension extending in the direction of the arrangement; and
performing a third operation that sets a page number on each of the extracted document images of the same group in an order of closeness from near to far distance to the origin.

What is claimed is:

1. An image processing apparatus comprising:
a processor configured to:
extract position coordinates of each document image from an entire image resulting from photographing a plurality of documents;
perform a first operation that extracts, from the document images included in the entire image, a first document image having two sides parallel with a direction of arrangement of the documents and having a first side of the two sides being a far side from a first coordinate axis, the first side having a shortest distance to the first coordinate axis, the first coordinate axis being in parallel with the direction of the arrangement of the documents set with respect to an origin of the entire image;
perform a second operation that extracts, as a document image of a same group, a second document image overlapping an extension of the first side of the extracted first document image, the extension extending in the direction of the arrangement; and
perform a third operation that sets a page number on each of the extracted document images of the same group in an order of closeness from near to far distance to the origin.

2. The image processing apparatus according to claim 1, wherein the processor is configured to exclude a document image having a page number out of the document images included in the entire image and iterate, until a document image without page number is no longer present, a fourth operation that sequentially performs the first operation, the second operation, and the third operation in order.

3. The image processing apparatus according to claim 1, wherein the processor is configured to, if a document image is rectangular with no side parallel with the direction of the arrangement or the document image is not rectangular, regard a shape of the document image as a rectangle that is in contact with a perimeter of the document image and has sides parallel with the direction of the arrangement.

4. The image processing apparatus according to claim 2, wherein the processor is configured to, if a document image is rectangular with no side parallel with the direction of the arrangement or the document image is not rectangular, regard a shape of the document image as a rectangle that is in contact with a perimeter of the document image and has sides parallel with the direction of the arrangement.

5. The image processing apparatus according to claim 1, wherein the processor is configured to modify at least one of a position of the origin of the entire image or the direction of the arrangement in response to an instruction from a user.

6. The image processing apparatus according to claim 2, wherein the processor is configured to modify at least one of a position of the origin of the entire image or the direction of the arrangement in response to an instruction from a user.

7. The image processing apparatus according to claim 5, wherein the processor is configured to: in response to the instruction from the user,
modify the position of the origin of the entire image to a first setting that sets, when the user faces a surface on which the document is placed, the position of the origin of the entire image to a top left position of the entire image and the direction of the arrangement to a horizontal direction of the entire image;
modify the position of the origin of the entire image to a second setting that sets, when the user faces the surface on which the document is placed, the position of the origin of the entire image to the top left position of the entire image and the direction of the arrangement to a vertical direction of the entire image;
modify the position of the origin of the entire image to a third setting that sets, when the user faces the surface on which the document is placed, the position of the origin of the entire image to a top right position of the entire image and the direction of the arrangement to the horizontal direction of the entire image; or
modify the position of the origin of the entire image to a fourth setting that sets, when the user faces the surface on which the document is placed, the position of the origin of the entire image to the top right position of the entire image and the direction of the arrangement to the vertical direction of the entire image.

8. The image processing apparatus according to claim 6, wherein the processor is configured to: in response to the instruction from the user,
modify the position of the origin of the entire image to a first setting that sets, when the user faces a surface on which the document is placed, the position of the origin of the entire image to a top left position of the entire image and the direction of the arrangement to a horizontal direction of the entire image;
modify the position of the origin of the entire image to a second setting that sets, when the user faces the surface on which the document is placed, the position of the origin of the entire image to the top left position of the entire image and the direction of the arrangement to a vertical direction of the entire image;
modify the position of the origin of the entire image to a third setting that sets, when the user faces the surface on which the document is placed, the position of the origin of the entire image to a top right position of the entire image and the direction of the arrangement to the horizontal direction of the entire image; or
modify the position of the origin of the entire image to a fourth setting that sets, when the user faces the surface on which the document is placed, the position of the origin of the entire image to the top right position of the entire image and the direction of the arrangement to the vertical direction of the entire image.

9. The image processing apparatus according to claim 1, wherein the processor is configured to display together with each of the document images a page number set on the document image in the entire image.

10. The image processing apparatus according to claim 2, wherein the processor is configured to display together with each of the document images a page number set on the document image in the entire image.

11. The image processing apparatus according to claim 9, wherein the processor is configured to:
be enabled to move each of the document images in the entire image in response to an instruction from a user; and
reset the page number of each of the document images in response to a movement of the document image.

12. The image processing apparatus according to claim 10, wherein the processor is configured to:
be enabled to move each of the document images in the entire image in response to an instruction from a user; and
reset the page number of each of the document images in response to a movement of the document image.

13. The image processing apparatus according to claim 1, wherein the processor is configured to display the document images arranged in an order of page numbers set on the document images.

14. The image processing apparatus according to claim 2, wherein the processor is configured to display the document images arranged in an order of page numbers set on the document images.

15. A non-transitory computer readable medium storing a program causing a computer to execute a process for processing information, the process comprising:
extracting position coordinates of each document image from an entire image resulting from photographing a plurality of documents;
performing a first operation that extracts, from the document images included in the entire image, a first document image having two sides parallel with a direction of arrangement of the documents and having a first side of the two sides being a far side from a first coordinate axis, the first side having a shortest distance to the first coordinate axis, the first coordinate axis being in parallel with the direction of the arrangement of the documents set with respect to an origin of the entire image;
performing a second operation that extracts, as a document image of a same group, a second document image overlapping an extension of the first side of the extracted first image document image, the extension extending in the direction of the arrangement; and
performing a third operation that sets a page number on each of the extracted document images of the same group in an order of closeness from near to far distance to the origin.

16. An image processing method comprising:
extracting position coordinates of each document image from an entire image resulting from photographing a plurality of documents;
performing a first operation that extracts, from the document images included in the entire image, a first document image having two sides parallel with a direction of arrangement of the documents and having a first side of the two sides being a far side from a first coordinate axis, the first side having a shortest distance to the first coordinate axis, the first coordinate axis being in parallel with the direction of the arrangement of the documents set with respect to an origin of the entire image;
performing a second operation that extracts, as a document image of a same group, a second document image overlapping an extension of the first side of the extracted first image document image, the extension extending in the direction of the arrangement; and
performing a third operation that sets a page number on each of the extracted document images of the same group in an order of closeness from near to far distance to the origin.
